(19) United States
(12) Patent Application Publication
(10) Pub. No.: US 2026/0234035 A1
(43) Pub. Date: Aug. 13, 2026

(54) METHOD FOR PLASMA TREATMENT OF A MIXTURE OF AT LEAST TWO LIQUID PHASES FOR THE SEPARATION OF THE TWO LIQUID PHASES OF THE MIXTURE

(71) Applicants: INSTITUT NATIONAL POLYTECHNIQUE DE TOULOUSE, Toulouse (FR); UNIVERSITE TOULOUSE III - Paul Sabatier, Toulouse (FR); CENTRE NATIONAL DE LA RECHERCHE SCIENTIFIQUE, PARIS (FR)

(72) Inventors: Nofel MERBAHI, Toulouse (FR); Jean-Philippe SARRETTE, Toulouse (FR); Olivier EICHWALD, Toulouse (FR); Djakaou IYA SOU, Toulouse (FR)

(21) Appl. No.: 19/155,554

(22) PCT Filed: Feb. 9, 2024
(86) PCT No.: PCT/FR2024/050183

§ 371 Date: Aug. 11, 2025

(30) Foreign Application Priority Data
Feb. 10, 2023 (FR) 2301247

(51) Int. Cl. C02F 1/48; B01D 17/04; B01D 17/06; C02F 101/32; C02F 103/10

(52) U.S. Cl. CPC C02F 1/487; B01D 17/04; B01D 17/06; C02F 2101/32; C02F 2103/10

(57) ABSTRACT

A process for treating a mixture of at least two liquid phases for separating the two liquid phases of the mixture, where the mixture is treated with a plasma.

### TECHNICAL FIELD

The present invention relates to a process for treating a mixture of at least two liquid phases with a view to separation of the two liquid phases of the mixture, to a process for treating wastewater containing at least said mixture of at least two liquid phases, to a process for treating an oil containing at least said mixture of at least two liquid phases and to an installation for treating a mixture of at least two liquid phases.

### TECHNOLOGICAL BACKGROUND

Crude oil production is almost systematically accompanied by production of water and hence a mixture of crude oil and water is recovered at the wellhead of an oil well. This mixture may comprise stable emulsions, in particular water-in-oil (W/O) emulsions, which give rise to various problems from the point of view of production but also during refining steps. It is therefore necessary to treat these mixtures of crude oil and water in order to break these emulsions.

It is known practice to treat these mixtures of crude oil and water by adding at least one chemical demulsifier so as to break these emulsions and thus obtain separation of the crude-oil and water phases. The mixture is then generally allowed to settle before each of the phases of the mixture is physically separated using a separator.

In the field of the treatment of domestic or industrial wastewater (also known as industrial effluents), it is known practice to treat wastewater by sedimentation or flocculation, generally preceded by coagulation, followed by settling.

Coagulation consists in injecting at least one chemical coagulant into the water to be treated with the aim of decreasing or neutralizing the electric charge borne by pollutants present in the water in the form of colloidal particles in suspension, in order to promote their subsequent agglomeration into the form of flocs.

Flocculation consists in injecting at least one chemical flocculant into the water, to which at least one chemical coagulant will preferably have been added beforehand, so as to form large particles that are easily separable or flocs, through agglomeration of colloidal particles present in suspension in the water. Flocculation is facilitated by prior implementation of coagulation. Flocculation may also be facilitated by adding, to the water to be treated upstream of or during flocculation, a granular material denser than water or ballast, such as sand, so as to ballast the flocs and thus promote and accelerate settling thereof. Such flocculation is commonly known as ballasted flocculation.

Purified water is then obtained by settling out the flocs found in suspension therein.

In order to increase the effectiveness of wastewater treatment, these coagulation, flocculation and settling techniques may be used in combination with advanced-oxidation techniques. These advanced-oxidation techniques include those requiring the addition of Fenton's reagent to the wastewater to be treated, making it possible to generate OH· free radicals from hydrogen peroxide in the presence of a transition metal such as iron. The OH· free radicals thus generated react with a wide range of organic pollutants, oxidizing them in the process.

These treatments, which require the addition of relatively large amounts of chemical demulsifiers, coagulants, flocculants or advanced oxidants to the wastewater to be treated, may involve relatively long treatment times, in particular due to the reaction rate of these chemicals. These treatments may for example require static treatment steps in tanks or vats.

Moreover, current demulsifiers, coagulants, flocculants or advanced oxidants may present risks to human health and be sources of pollution of the environment.

From WO2014/172504 a process is known that allows separation of liquid phases of a water/oil emulsion, in which process the emulsion is treated with a flux of ions formed by means of a corona discharge in a low-current (or glow) regime, between an earthed collecting electrode that is submerged in the emulsion, and an emitting electrode that is necessarily kept at a distance from the emulsion and that has a potential difference, with respect to the emitting electrode, equal to or greater than a threshold value allowing such a corona discharge to be produced.

Throughout the present text, the term “plasma” designates, in a manner known per se, a state of matter or a fourth state of matter (solid, liquid, gas and plasma). The plasma state differs from the gaseous state in the presence both of neutral particles (of density n₀) and charged particles (ions and electrons, of respective densities nᵢ and nₑ). A gas is converted into a plasma when the kinetic energy of at least some of its constituent particles becomes higher than the ionization energy of these particles.

Unlike a gas, which is an electrical insulator, a plasma includes free charges and is electrically conductive, while remaining electrically neutral from a macroscopic point of view (nᵢ=nₑ). This particularity means that plasmas are able to interact with electric and/or magnetic fields. Various classes of plasmas are known, characterized by the proportion of charged particles that they contain, which is referred to as their degree of ionization (δ):

$$δ = \frac{{n}_{e}}{{n}_{0} + {n}_{e}}$$

A distinction is made between highly ionized plasmas (referred to as hot plasmas, which make up more than 99% of the known matter in the universe), the degree of ionization of which approaches unity (δ=0.1-1), and weakly ionized or cold plasmas (δ=10⁷-10⁻⁴), which include laboratory plasmas. Among cold plasmas, a distinction is conventionally made between thermal plasmas, in which all the particles have the same temperature (thermodynamic equilibrium), and non-equilibrium plasmas, in which the electrons have a much higher average kinetic energy than the heavy particles (ions and neutral particles). This difference in kinetic energy is in most cases achieved through the action of an electromagnetic field, which accelerates charged particles, and by the difference in mass between electrons and ions.

The methods for generating cold plasmas—also called plasma discharges—vary depending on their pressure regime, the geometry and the dielectric nature of the electrodes across which the potential difference used to generate the electric field is applied or the frequency of variation of this potential, for example.

At atmospheric pressure, a simple means for generating discharges consists in adjusting the geometry of the electrodes in order to make them asymmetric (tip-plane and wire-cylinder geometries are in particular used). In the case of a positive discharge, a high voltage is applied to the electrode of small radius of curvature, inducing a high field in its vicinity. Electronic avalanches take place in this region and generate, under certain conditions, a plasma in the form of a luminous corona (and hence the name corona discharge).

For a given tip-plane electrode geometry, a number of modes of operation of a corona discharge may be observed depending on the voltage applied across the electrodes, these different modes of operation being characterized by their average current (number of electrons flowing between the two electrodes) and being:
a glow or onset-streamer mode, characterized by a low average current at low voltage levels, and corresponding to the mode of operation described in WO2014/172504. From a temporal point of view, the current pulses are weak and erratic (no defined frequency of appearance). A low level of localized luminescence, indicative of the existence of a plasma, is observed solely in the vicinity of the tip electrode;
a streamer mode characterized by, beyond a voltage greater than the voltage leading to the glow mode and depending in particular on the radius of curvature of the tip electrode and on the tip-plane distance, a sharp increase in the measured average current. The current pulses have a higher amplitude than in the glow regime and appear at a regular frequency. Even though they remain limited in time since their duration is of the order of one hundred nanoseconds (ns), these pulses correspond to the establishment of a non-permanent conduction channel in the inter-electrode zone. The streamer mode obtained with tip-plane electrodes is characterized by a luminous zone corresponding to the discharge and extending from the tip of the tip electrode to a point on the plane electrode;
above a voltage applied in streamer mode, a rapid transition to an electric-arc regime is observed, in which regime the duration of establishment of the discharge in the tip-plane space becomes constant (permanent short-circuit) and the gas becomes very hot.

### SUMMARY OF THE INVENTION

### First Subject of the Invention

A first subject of the invention is a process for treating a mixture of at least two liquid phases with a view to separation of the two liquid phases of the mixture, wherein the mixture is treated with a plasma.

The two liquid phases are preferably immiscible.

One of the two liquid phases may be continuous and the other may be dispersed in the continuous phase.

One of the two liquid phases may be aqueous and the other may be an oil.

For example, the mixture to be treated comprises a continuous aqueous phase in which an oil phase is dispersed, or a continuous oil phase in which an aqueous phase is dispersed.

The aqueous phase may be water, optionally containing one or more salts in solution, such as calcium, magnesium or sodium chlorides for example.

The oil phase may be a crude oil; a lubricating oil, in particular an engine oil, a transmission oil, a hydraulic oil, a two-stroke oil or a cutting oil; a vegetable oil, in particular an olive or sunflower oil; or one of their mixtures.

For example, the mixture to be treated is a mixture of crude oil and water optionally containing one or more salts in solution, such as calcium, magnesium or sodium chlorides for example.

The volume ratio of the oil phase relative to the aqueous phase may be between 1:999 and 999:1, preferably between 1:99 and 99:1.

The mixture to be treated may be an emulsion. In this case, the process is a process for treating an emulsion with a view to breaking it, in which the emulsion is treated with a plasma. The process then makes it possible to destabilize the emulsion and therefore break it so as to separate the phases of the emulsion.

The process may be applied to any industry in which mixtures, and in particular emulsions, must be prepared and/or treated. Mention may for example be made of the following: the pharmaceutical industry; the industry of organic and chemical fertilizers and of agents for protecting plants; the plastic industry; the construction industry; paint, varnish and wax industries; paper and packaging industries; tanneries and the leather industry; mining; the nuclear industry; industries in which electrolysis and polishing baths are employed; the petroleum and petrochemical industries; the industry of additives for mineral oils; the adhesive industry; the chemical industry; the photographic industry; industrial laundries; and the industry of detergents and cleaning agents.

In particular, mention may be made of the following:
the agri-food business, in activities such as, for example, processing oilseeds and fatty substances, curing and salting meat on an industrial scale, slaughtering animals or disposing of their remains,
the metallurgical industry, in activities such as, for example, the industrial manufacture of cutting tools, which produces grinding sludges,
the mechanical and metal-working industries, oil-rich waste products being generated by machine tools (in particular residues from the filtration of cutting fluids) or painting booths,
the textile industry, in particular in the activities of washing and scouring wool.

The emulsion may be a simple emulsion, in particular of oil-in-water (O/W), water-in-oil (W/O) or oil-in-oil type (i.e. a mixture of at least two different immiscible oil phases in which one of the oil phases is continuous and the other is dispersed in the continuous phase); a multiple emulsion, in particular of oil-in-water-in-oil (O/W/O) or water-in-oil-in-water (W/O/W) type; or one of their mixtures.

The mixture to be treated may also comprise a solid phase dispersed in at least one of the two liquid phases, in particular in both liquid phases.

The solid phase may be a plurality of dispersed solid particles, in particular of colloidal size.

In the case where the mixture to be treated also comprises a solid phase, the treatment of the mixture by the plasma may not only allow separation of the two liquid phases of the mixture but also separation of the solid phase of the mixture.

The plasma may be generated between at least two electrodes, in particular between at least one ground electrode and at least one high-voltage electrode, across which electrodes a constant or periodic voltage is applied, having in particular a sinusoidal, Gaussian or triangular shape, a sawtooth, square, rectangular or pulsed shape.

When a pulsed voltage is applied, the pulse in particular has a width between 1 ns and 10 μs, for example a width between 50 ns and 600 ns, and/or the pulse in particular has a square, triangular or Gaussian shape. For example, it is possible to use a periodic pulsed voltage with pulses having a width of 500 ns and a duration of 10 ms between two pulses. It is also possible to use a pulsed voltage comprising pulse trains (also referred to as “burst mode”).

Preferably, a high, positive or negative, voltage is applied to the one or more high-voltage electrodes.

The constant or periodic voltage may have an amplitude between 10 V and 100 kV, preferably between 1 kV and 10 kV.

The periodic voltage may have a frequency between 1 Hz and 1 MHz, preferably between 100 Hz and 100 kHz.

Preferably, the electrodes are placed so as to expose the mixture to be treated to the plasma.

More particularly, the electrodes are placed so as to generate the plasma in contact with or in the mixture to be treated.

At least one of the electrodes, in particular both electrodes, may not make contact with the mixture to be treated. For example, the electrode or electrodes may be located in a gas phase located in proximity to the mixture to be treated, in particular a gas phase located above the surface of the mixture. Such a configuration of the electrodes may make it possible to generate the plasma in contact with the mixture to be treated, for example in a gas phase located in proximity to the mixture, in particular above the surface of the mixture.

For example, one of the electrodes does not make contact with the mixture to be treated, in particular being located in a gas phase located in proximity to the mixture, for example a gas phase located above the surface of the mixture, and the other electrode makes contact with the mixture to be treated, in particular being submerged in the mixture.

As a variant, both electrodes make contact with the mixture to be treated. Such a configuration of the electrodes may make it possible to generate the plasma in the mixture to be treated.

In one example, both electrodes are submerged in the mixture to be treated.

In another example, the mixture to be treated is contained in a container formed by walls. In the case where only one of the two electrodes makes contact with the mixture, said electrode may be formed by at least one of the walls of the container. In the case where both electrodes make contact with the mixture, said electrodes may each be formed by one wall of the container.

In one particular configuration, the plasma is generated by an electrode array, said electrode array comprising at least three, four, five, six or more electrodes, including at least one ground electrode and at least one high-voltage electrode.

The electrode array may comprise a plurality of high-voltage electrodes and/or a plurality of ground electrodes. For example, the electrode array comprises a plurality of high-voltage electrodes and one ground electrode; a plurality of ground electrodes and one high-voltage electrode; or a plurality of high-voltage electrodes and a plurality of ground electrodes.

When the electrode array comprises a plurality of high-voltage electrodes, the latter may be supplied by a single voltage generator. As a variant, the high-voltage electrodes are each supplied by one voltage generator, these voltage generators being identical or not. Thus, the high-voltage electrodes may each be supplied with one voltage, these voltages possibly being identical or not.

By “identical voltages”, what is meant is voltages having identical characteristics, in particular in terms of type of voltage (DC or periodic voltage), of amplitude, of frequency, of signal shape, etc.

The plasma may be chosen from a plasma of dielectric-barrier-discharge type (also known as a DBD for Dielectric Barrier Discharge), of corona type and of cold-plasma-jet type.

In the case where the plasma is a plasma of dielectric-barrier-discharge type, either only one of the electrodes is covered with a dielectric material (for example the ground electrode or the high-voltage electrode), or both electrodes are covered with a dielectric material.

In the case where the plasma is a plasma of corona type, the two electrodes have asymmetric geometries, for example tip/plane, wire/cylinder, etc., so as to allow a high electric field to be created in the vicinity of the electrode of small radius of curvature.

The plasma of cold-plasma-jet type may be a cold plasma jet of corona type, a cold plasma jet of dielectric-barrier-discharge type, a microwave plasma jet or any other type of cold plasma jet.

In the case where the plasma is a cold plasma jet of corona type, the high-voltage electrode is placed at the center of a tube, such as a capillary tube for example, this tube in particular being made of quartz. A gas, such as the helium for example, flows through the tube. The plasma is then generated in the tube between the ground electrode and the high-voltage electrode and propagates on exiting the tube into the surrounding gas, which may or may not be identical to the gas flowing through the tube.

In one particular configuration, the ground electrode has an annular shape and encircles the tube. This particular cold-plasma-jet configuration is then not qualified of corona type.

In the case where the plasma is a cold plasma jet of dielectric-barrier-discharge type, the high-voltage and ground electrodes both have an annular shape and encircle a tube with a dielectric wall, such as a capillary tube with a dielectric wall for example, the dielectric wall of the tube in particular being made of quartz. A gas, such as the helium for example, flows through the tube. The plasma is then generated in the tube between the ground electrode and the high-voltage electrode and propagates on exiting the tube into the surrounding gas, which may or may not be identical to the gas flowing through the tube.

The gas used to produce the plasma may be chosen from a molecular gas, in particular ambient air; a noble gas, in particular argon or helium; and one of their mixtures.

The process may be applied to a stream of mixture. For example, a stream of the mixture is made to flow through a treatment zone formed between at least two electrodes across which a constant or periodic voltage is applied, in particular one having a sinusoidal, Gaussian, triangular, sawtooth, square, rectangular or pulsed shape. This is particularly advantageous insofar as the process may thus make it possible to continuously treat a stream of the mixture with a view to separation of the two liquid phases of the mixture. This may also allow the process to be simplified, as it makes it possible to avoid the need to use treatment tanks or vats.

The stream of mixture may be made to flow by gravity or using a motorized system, in particular a pump actuated by an electric motor, a peristaltic pump for example.

Alternatively, the mixture to be treated may be sprayed in the form of droplets into the plasma. The treatment of the droplets of the mixture with the plasma makes it possible to separate the two phases of the droplets and, when the droplets thus treated are combined again, the two phases remain separated.

The duration of treatment of the mixture, in particular of the emulsion, with the plasma may be between 1 second and 10 hours, preferably between 5 seconds and 60 minutes. Such a duration is dependent on the mixture to be treated, in particular on the type of mixture to be treated, on its volume and on whether or not it flows as a stream; on the type of plasma used; and on the configuration of the electrodes, in particular on their positioning, their number, and the characteristics of the voltage supplied to them (for example voltage type (DC or periodic voltage), amplitude, frequency, signal shape, etc.).

It is possible to heat the mixture so as to raise it to a temperature greater than or equal to room temperature, in particular to a temperature ranging from 20° C. to 90° C., preferably ranging from 60° C. to 90° C., simultaneously with its treatment with the plasma. Specifically, this may allow the separation of the two liquid phases of the mixture to be improved.

The mixture may be stirred simultaneously with its treatment with the plasma. This is particularly advantageous in the case where the process is not applied to a stream of mixture. Specifically, this may allow the separation of the two liquid phases of the mixture to be improved.

The separation of the two liquid phases of the mixture, and optionally of the solid phase of the mixture, is preferably irreversible. This means that if the treated mixture (in particular the treated emulsion) is supplied with the same amount of energy as used to form the initial mixture (in particular the initial emulsion), for example the same amount of stirring is applied thereto, it is not possible to again form the initial mixture (in particular the initial emulsion). The separation of the two liquid phases, and optionally of the solid phase of the mixture, observed within the mixture treated with the plasma is therefore stable.

The duration of the separation of the two liquid phases of the mixture, in particular of the emulsion, and optionally of the solid phase of the mixture, may be between 1 second and 10 hours, and is preferably a few seconds. Such a duration is dependent on the mixture to be treated, in particular on the type of mixture to be treated, on its volume and on whether or not it flows as a stream; on the type of plasma used; and on the configuration of the electrodes, in particular on their positioning, their number, and the characteristics of the voltage supplied to them (for example voltage type (DC or periodic voltage), amplitude, frequency, signal shape, etc.). This is particularly advantageous insofar as the process may thus make it possible to treat large amounts of mixture in short times.

Preferably, no phase-separating chemicals, such as chemical demulsifiers, coagulants, flocculants or advanced oxidants, in particular bases, acids, salts (especially of sodium chloride or metal salts, for example of iron or aluminum), hydrogen peroxide, cyclodextrins, etc., are added to the mixture. Thus, only exposure to the plasma is able to allow the two liquid phases of the mixture to be separated.

At least one of the two liquid phases of the mixture, better still each of the two liquid phases of the mixture, may be recovered after the separation of the two liquid phases of the mixture.

The mixture may be a fluid generated in the petroleum industry, such as a fluid recovered at the wellhead of an oil well or a drilling fluid; a cutting fluid, for example used when working metals; domestic, agricultural or industrial wastewater, such as washing or rinsing water originating from a process for stripping, sizing or applying paint, or water resulting from washing or scouring wool.

The process may have characteristics that may vary depending on certain parameters, in particular depending on the mixture to be treated, in particular on the type of mixture to be treated, on its volume and on whether or not it flows as a stream; on the type of plasma used; and on the configuration of the electrodes, in particular on their positioning, their number, and the characteristics of the voltage supplied to them (for example voltage type (DC or periodic voltage), amplitude, frequency, signal shape, etc.).

### Second Subject of the Invention

A second subject of the invention is a process for treating wastewater containing at least one mixture of at least two liquid phases such as described above, wherein said wastewater is treated by implementing the process such as described above.

The wastewater to be treated may be domestic, agricultural or industrial wastewater, such as washing or rinsing water originating from a process for stripping, sizing or applying paint, or water resulting from washing or scouring wool.

Preferably, the wastewater to be treated contains at least one aqueous phase and at least one oil phase.

Preferably, after the treatment of the wastewater with the plasma, the aqueous phase is recovered. The aqueous phase thus recovered corresponds to purified water.

### Third Subject of the Invention

A third subject of the invention is a process for treating an oil containing at least one mixture of at least two liquid phases such as described above, wherein said oil is treated by implementing the process such as described above.

The oil to be treated may be a lubricating oil, in particular an engine oil, a transmission oil, a hydraulic oil, a two-stroke oil or a cutting oil; a vegetable oil, in particular an olive or sunflower oil; or one of their mixtures.

Preferably, the oil to be treated contains at least one aqueous phase and at least one oil phase.

### Fourth Subject of the Invention

A fourth subject of the invention, independently or in combination with the foregoing, is an installation for treating a mixture of at least two liquid phases, in particular in the context of implementation of the process such as described above, comprising:
a reactor intended to contain or containing the mixture to be treated, the mixture to be treated being able in particular to flow through the reactor in a continuous stream;
at least two electrodes, in particular at least one ground electrode and at least one high-voltage electrode, which are arranged so as to generate a plasma in contact with or in the mixture to be treated with a view to separation of the two liquid phases of the mixture;
at least one voltage generator for supplying the electrodes.

The mixture to be treated may be an emulsion. For example, it may be a question of a simple emulsion, in particular of oil-in-water (O/W), water-in-oil (W/O) or oil-in-oil type; or of a multiple emulsion, in particular of oil-in-water-in-oil (O/W/O) or water-in-oil-in-water (W/O/W) type.

The reactor may be a tank.

The reactor may be fed with the mixture to be treated, for example through actuation of a valve.

At least one of the electrodes, in particular both electrodes, may not make contact with the mixture to be treated. Such a configuration of the electrodes may make it possible to generate the plasma in contact with the mixture to be treated.

As a variant, both electrodes make contact with the mixture to be treated. Such a configuration of the electrodes may make it possible to generate the plasma in the mixture to be treated.

Preferably, the voltage generator is a high-voltage generator. In particular, the voltage generator is a generator of a high voltage that is DC or periodic, and that in particular has a sinusoidal, Gaussian, triangular, sawtooth, square, rectangular or pulsed shape.

According to the first, second, third and fourth subjects of the invention, the mode of production of the plasma is a mode of streamer type in which the current measured between electrodes for forming the plasma is greater than the current generated by a discharge in glow mode.

According to the first, second, third and fourth subjects of the invention, the mode of production of the plasma is a mode of streamer type in which the current measured between electrodes is a pulsed current of substantially regular frequency, in particular of regular frequency.

According to the first, second, third and fourth subjects of the invention, the mode of production of the plasma is a mode of streamer type in which the pulses of the pulsed current have a duration of the order of about one hundred nanoseconds.

According to the first, second, third and fourth subjects of the invention, the mode of production of the plasma is a mode of streamer type in which a non-permanent conduction channel is established in the inter-electrode zone.

According to certain embodiments of the first, second, third and fourth subjects of the invention, in which the mode of production of the plasma is a mode of streamer type obtained with electrodes of tip-plane type, a luminous zone corresponding to the discharge extends from the tip of the tip electrode to at least one point on the plane electrode.

According to the first, second, third and fourth subjects of the invention, the mode of production is of streamer type in which a plasma is generated independently of the polarity of the electrodes. The high-voltage electrode may make contact with said mixture of at least two liquid phases to be separated. The ground electrode may make contact with said mixture of at least two liquid phases to be separated. The high-voltage electrode and the ground electrode may make contact with said mixture of at least two liquid phases to be separated.

According to certain embodiments of the invention, the mode of production of the plasma is of streamer type in which one of the electrodes is a tip electrode. Such a mode of production of streamer type makes it possible for the tip electrode to be placed (and kept) in contact with said mixture of at least two liquid phases to be separated during the treatment of said mixture, in particular without adversely affecting the effectiveness of the process.

### BRIEF DESCRIPTION OF THE FIGURES

The following description provided with reference to the appended drawings, which are given by way of non-limiting example, will make it easy to understand what the invention consists of and how it may be implemented. In the appended figures:

FIG. 1 is a schematic view showing one example of a process according to the invention in which the mixture is treated with a plasma of dielectric-barrier-discharge type,

FIG. 2 shows one variant of FIG. 1,

FIG. 3 shows one variant of FIG. 1,

FIG. 4 shows one variant of FIG. 3,

FIG. 5 shows one variant of FIG. 1,

FIG. 6 shows one variant of FIG. 5,

FIG. 7 shows one variant of FIG. 1,

FIG. 8 shows one variant of FIG. 7,

FIG. 9 shows one variant of FIG. 7,

FIG. 10 shows one variant of FIG. 9,

FIG. 11 shows one variant of FIG. 7,

FIG. 12 shows one variant of FIG. 11,

FIG. 13 shows one variant of FIG. 1,

FIG. 14 shows one variant of FIG. 2,

FIG. 15 shows one variant of FIG. 3,

FIG. 16 shows one variant of FIG. 4,

FIG. 17 shows one variant of FIG. 5,

FIG. 18 shows one variant of FIG. 6,

FIG. 19 shows one variant of FIG. 7,

FIG. 20 shows one variant of FIG. 8,

FIG. 21 shows one variant of FIG. 9,

FIG. 22 shows one variant of FIG. 10,

FIG. 23 shows one variant of FIG. 11,

FIG. 24 shows one variant of FIG. 12,

FIG. 25 is a schematic view showing one example of a process according to the invention in which the mixture is treated with a plasma of corona type,

FIG. 26 shows one variant of FIG. 25,

FIG. 27 shows one variant of FIG. 25,

FIG. 28 shows one variant of FIG. 27,

FIG. 29 shows one variant of FIG. 27,

FIG. 30 shows one variant of FIG. 29,

FIG. 31 shows one variant of FIG. 29,

FIG. 32 shows one variant of FIG. 30,

FIG. 33 is a schematic view showing one example of a process according to the invention in which the mixture is treated with a cold plasma jet of corona type,

FIG. 34 shows one variant of FIG. 33,

FIG. 35 shows one variant of FIG. 33,

FIG. 36 shows one variant of FIG. 33,

FIG. 37 shows one variant of FIG. 36,

FIG. 38 shows one variant of FIG. 36,

FIG. 39 is a schematic view showing one example of a process according to the invention in which the mixture is treated with a cold plasma jet of dielectric-barrier-discharge type,

FIG. 40 shows one variant of FIG. 39,

FIG. 41 shows one variant of FIG. 39,

FIG. 42 is a schematic view showing one example of a process according to the invention in which a stream of mixture is treated,

FIG. 43 shows one variant of FIG. 42,

FIG. 44 is a schematic view showing another example of a process according to the invention in which a stream of mixture is treated, and

FIG. 45 shows one variant of FIG. 44.

### DESCRIPTION OF ONE OR MORE EMBODIMENTS

In the figures, and unless otherwise stated, elements that are identical have been designated by the same reference signs.

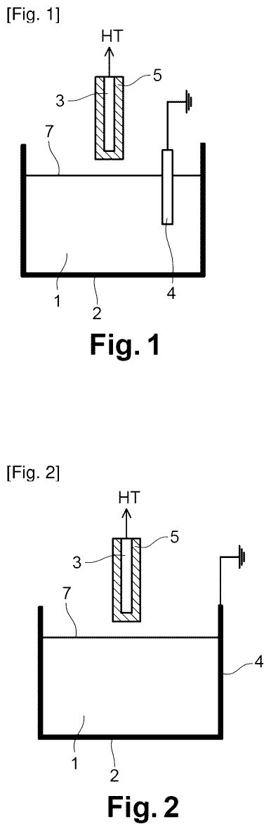

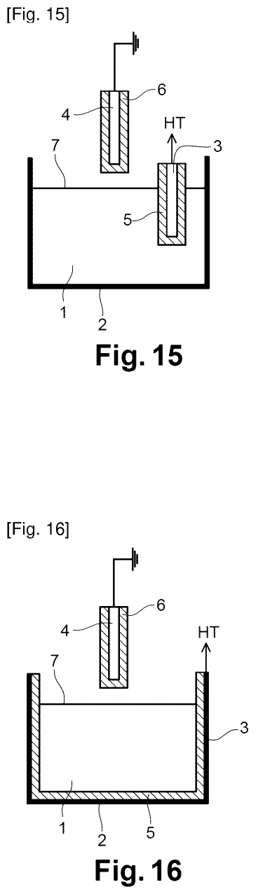

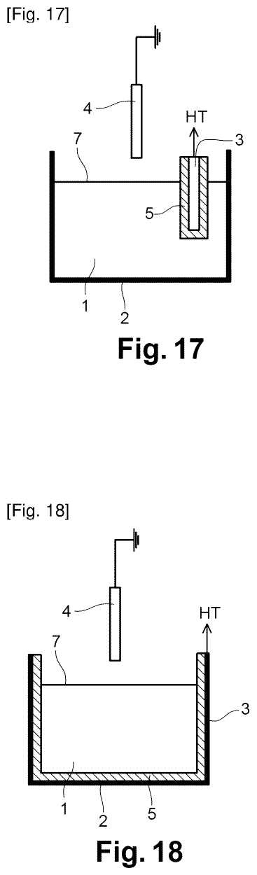

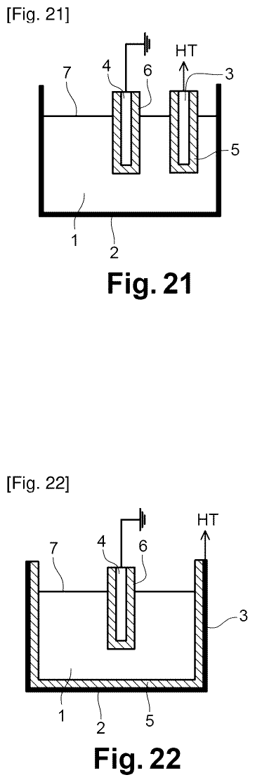

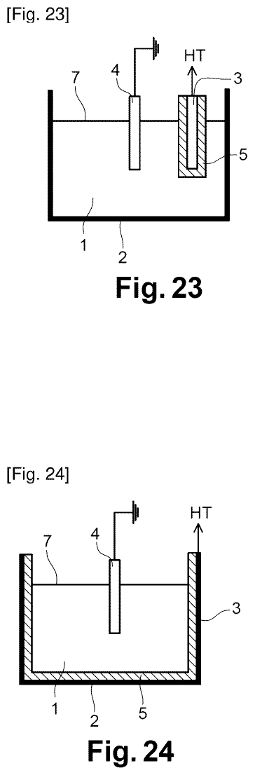

FIGS. 1 to 24: Examples of Processes According to the Invention in which the Mixture is Treated with a Plasma of Dielectric-Barrier-Discharge Type

FIG. 1 shows one example of a process according to the invention. In this example, a mixture 1 to be treated comprising at least two liquid phases is contained in a container 2 formed by walls. The mixture 1 to be treated may be an emulsion. In this example, the plasma used to treat the mixture 1 is a plasma of dielectric-barrier-discharge type. In this example, the latter is generated between a high-voltage electrode 3, which is covered with a dielectric material 5, and a ground electrode 4, which for its part is not covered with dielectric material. The high-voltage electrode 3 does not make contact with the mixture 1 to be treated. It is in a gas phase located in proximity to the mixture 1 to be treated, and in particular in a gas phase located above the surface 7 of the mixture 1 to be treated, as is illustrated in FIG. 1. The ground electrode 4 makes contact with the mixture 1 to be treated, and is in particular submerged in the mixture 1 to be treated, as is illustrated in FIG. 1.

FIG. 2 shows one variant of FIG. 1, in which the ground electrode 4 is formed by at least one wall of the container 2.

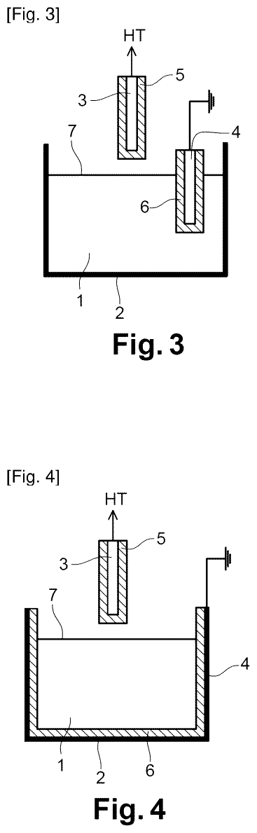

FIG. 3 shows one variant of FIG. 1, in which the ground electrode 4 is covered with a dielectric material 6.

FIG. 4 shows one variant of FIG. 3, in which the ground electrode unit 4 is formed by at least one wall of the container 2. Said wall is covered with a dielectric material 6.

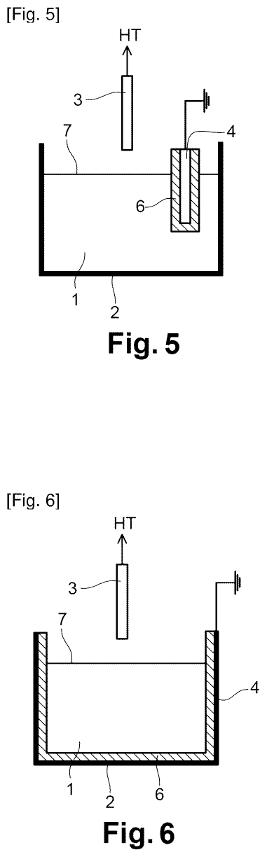

FIG. 5 shows one variant of FIG. 1, in which the high-voltage electrode 3 is not covered with dielectric material and in which the ground electrode 4 is for its part covered with dielectric material 6.

FIG. 6 shows one variant of FIG. 5, in which the ground electrode 4 is formed by at least one wall of the container 2. Said wall is covered with a dielectric material 6.

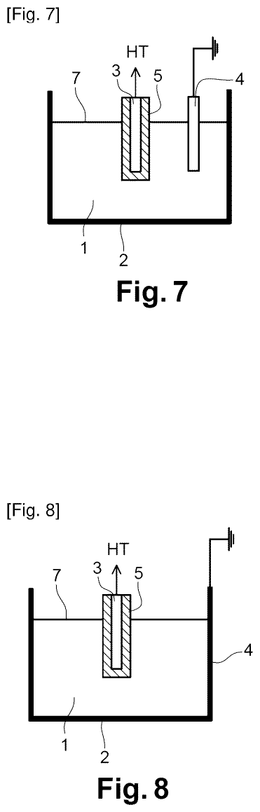

FIG. 7 shows one variant of FIG. 1, in which the high-voltage electrode 3 covered with a dielectric material 5 is submerged in the mixture 1 to be treated.

FIG. 8 shows one variant of FIG. 7, in which the ground electrode 4 is formed by at least one wall of the container 2.

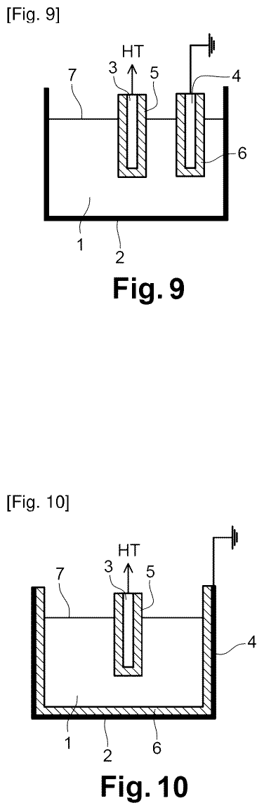

FIG. 9 shows one variant of FIG. 7, in which the ground electrode 4 is covered with a dielectric material 6.

FIG. 10 shows one variant of FIG. 9, in which the ground electrode 4 is formed by at least one wall of the container 2. Said wall is covered with a dielectric material 6.

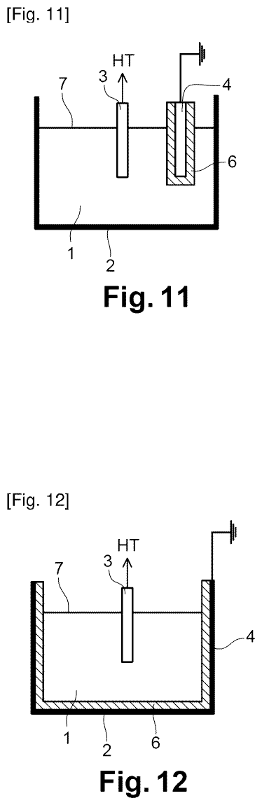

FIG. 11 shows one variant of FIG. 7, in which the high-voltage electrode 3 is not covered with dielectric material and in which the ground electrode 4 is for its part covered with dielectric material 6.

FIG. 12 shows one variant of FIG. 11, in which the ground electrode 4 is formed by at least one wall of the container 2. Said wall is covered with a dielectric material 6.

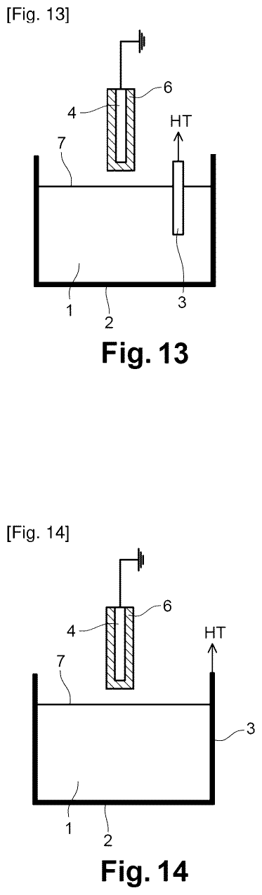

FIGS. 13 to 24 show variants of FIGS. 1 to 12, respectively, in which the polarities of the electrodes are reversed.

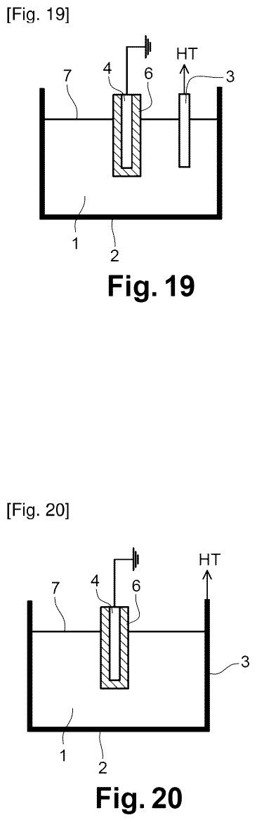

Thus, in FIGS. 1 to 6, the high-voltage electrode 3 does not make contact with the mixture 1 to be treated and the ground electrode 4 makes contact with the mixture 1 to be treated, whereas, in FIGS. 7 to 12, both the high-voltage electrode 3 and the ground electrode 4 make contact with the mixture 1 to be treated. In FIGS. 13 to 18, the ground electrode 4 does not make contact with the mixture 1 to be treated and the high-voltage electrode 3 makes contact with the mixture 1 to be treated, whereas, in FIGS. 19 to 24, both the ground electrode 4 and the high-voltage electrode 3 make contact with the mixture 1 to be treated.

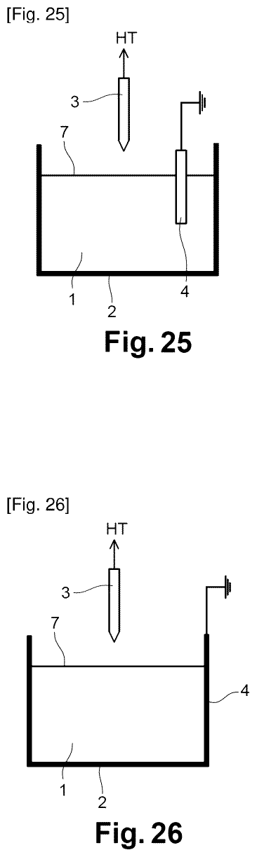

FIGS. 25 to 32: Examples of processes according to the invention in which the mixture is treated with a plasma of corona type

FIG. 25 shows another example of a process according to the invention. In this example, a mixture 1 to be treated comprising at least two liquid phases is contained in a container 2 formed by walls. The mixture 1 to be treated may be an emulsion. In this example, the plasma used to treat the mixture 1 is a plasma of corona type. In this example, the latter is generated between a high-voltage electrode 3 having a small radius of curvature, and in particular a tip shape, as illustrated in FIG. 25, and a ground electrode 4 having a large radius of curvature, and in particular a plane shape, as illustrated in FIG. 25. The high-voltage electrode 3 does not make contact with the mixture 1 to be treated. It is in a gas phase located in proximity to the mixture 1 to be treated, and in particular in a gas phase located above the surface 7 of the mixture 1 to be treated, as is illustrated in FIG. 25. The ground electrode 4 makes contact with the mixture 1 to be treated, and is in particular submerged in the mixture 1 to be treated, as is illustrated in FIG. 25.

FIG. 26 shows one variant of FIG. 25, in which the ground electrode 4 is formed by at least one wall of the container 2.

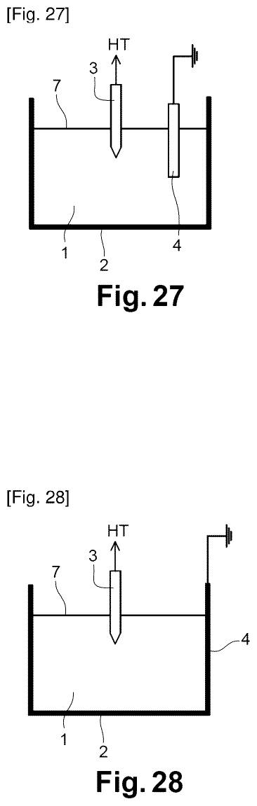

FIG. 27 shows one variant of FIG. 25, in which the high-voltage electrode 3 is submerged in the mixture 1 to be treated.

FIG. 28 shows one variant of FIG. 27, in which the ground electrode 4 is formed by at least one wall of the container 2.

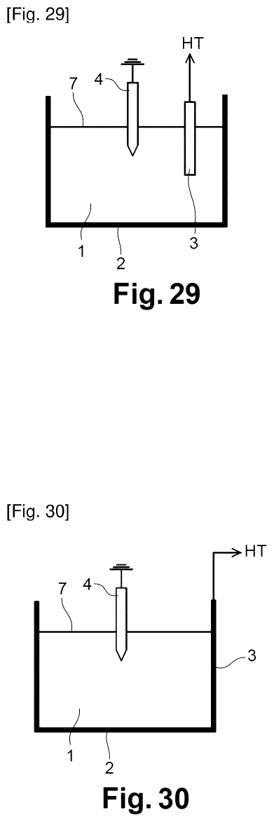

FIG. 29 shows one variant of FIG. 27, in which the ground electrode 4 has a small radius of curvature, and in particular a tip shape, while the high-voltage electrode 3 has a large radius of curvature, and in particular a plane shape.

FIG. 30 shows one variant of FIG. 29, in which the high-voltage electrode 3 is formed by at least one wall of the container 2.

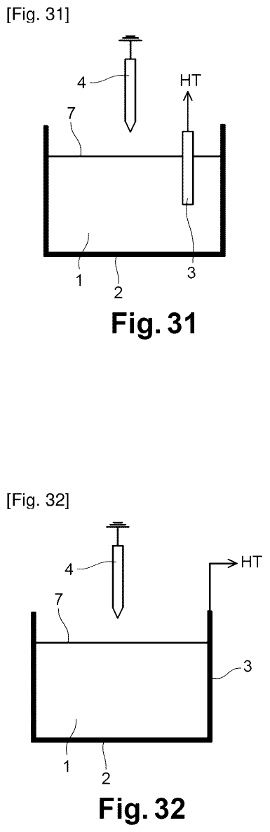

FIG. 31 shows one variant of FIG. 29, in which the ground electrode 4 does not make contact with the mixture 1 to be treated. It is in a gas phase located in proximity to the mixture 1 to be treated, and in particular in a gas phase located above the surface 7 of the mixture 1 to be treated, as is illustrated in FIG. 31.

FIG. 32 shows one variant of FIG. 30, in which the ground electrode 4 does not make contact with the mixture 1 to be treated. It is in a gas phase located in proximity to the mixture 1 to be treated, and in particular in a gas phase located above the surface 7 of the mixture 1 to be treated, as is illustrated in FIG. 32.

Thus, in FIGS. 25 and 26, the high-voltage electrode 3 does not make contact with the mixture 1 to be treated and the ground electrode 4 makes contact with the mixture 1 to be treated, whereas, in FIGS. 27 to 30, both the high-voltage electrode 3 and the ground electrode 4 make contact with the mixture 1 to be treated. In FIGS. 31 and 32, the ground electrode 4 does not make contact with the mixture 1 to be treated and the high-voltage electrode 3 makes contact with the mixture 1 to be treated.

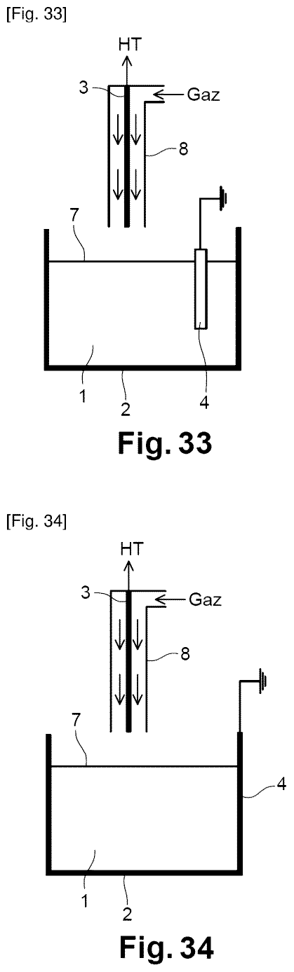

FIGS. 33 to 38: Examples of Processes According to the Invention in which the Mixture is Treated with a Cold Plasma Jet of Corona Type

FIG. 33 shows another example of a process according to the invention. In this example, a mixture 1 to be treated comprising at least two liquid phases is contained in a container 2 formed by walls. The mixture 1 to be treated may be an emulsion. In this example, the plasma used to treat the mixture 1 is a cold plasma jet of corona type. In this example, the high-voltage electrode 3 is placed at the center of a tube 8, such as a capillary tube for example, this tube 8 in particular being made of quartz. A gas, such as the helium for example, flows through the tube 8. The high-voltage electrode 3 does not make contact with the mixture 1 to be treated. It is in a gas phase located in proximity to the mixture 1 to be treated, and in particular in a gas phase located above the surface 7 of the mixture 1 to be treated, as is illustrated in FIG. 33. The ground electrode 4 makes contact with the mixture 1 to be treated, and is in particular submerged in the mixture 1 to be treated, as is illustrated in FIG. 33. The plasma is then generated in the tube 8 between the ground electrode 4 and the high-voltage electrode 3 and propagates on exiting the tube 8 into the surrounding gas, which may or may not be identical to the gas flowing through the tube 8.

FIG. 34 shows one variant of FIG. 33, in which the ground electrode 4 is formed by at least one wall of the container 2.

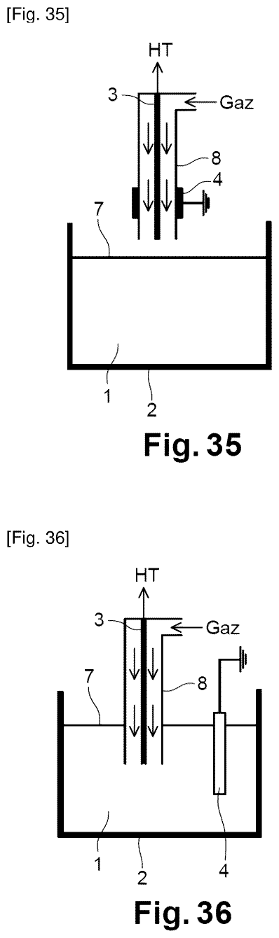

FIG. 35 shows one variant of FIG. 33, in which the ground electrode 4 has an annular shape and encircles the tube 8. This variant of the cold plasma jet, illustrated in FIG. 35, is then not qualified of corona type.

FIG. 36 shows one variant of FIG. 33, in which the high-voltage electrode 3 placed at the center of the tube 8 is submerged in the mixture 1 to be treated.

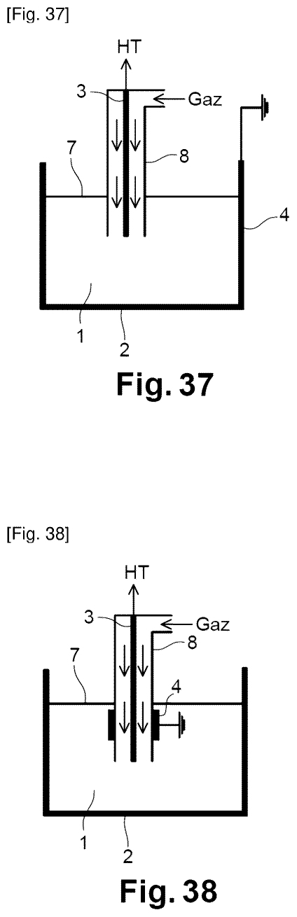

FIG. 37 shows one variant of FIG. 36, in which the ground electrode 4 is formed by at least one wall of the container 2.

FIG. 38 shows one variant of FIG. 36, in which the ground electrode 4 has an annular shape and encircles the tube 8. This variant of the cold plasma jet, illustrated in FIG. 38, is then not qualified of corona type.

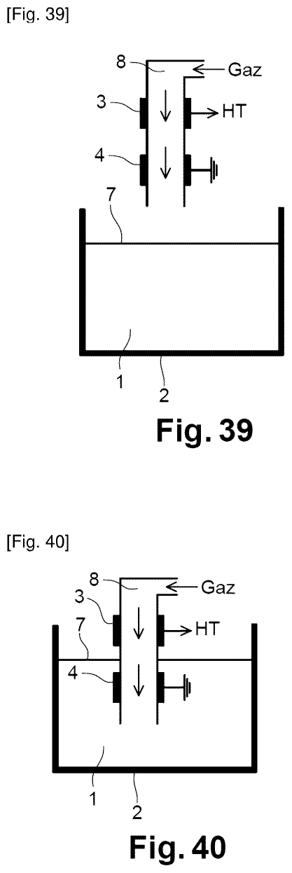

FIGS. 39 to 41: Examples of Processes According to the Invention in which the Mixture is Treated with a Cold Plasma Jet of Dielectric-Barrier-Discharge Type

FIG. 39 shows another example of a process according to the invention. In this example, a mixture 1 to be treated comprising at least two liquid phases is contained in a container 2 formed by walls. The mixture 1 to be treated may be an emulsion. In this example, the plasma used to treat the mixture 1 is a cold plasma jet of dielectric-barrier-discharge type. In this example, the high-voltage electrode 3 has an annular shape and encircles a tube 8 formed from a dielectric wall, such as a capillary tube with a dielectric wall for example, the dielectric wall of the tube 8 in particular being made of quartz. A gas, such as the helium for example, flows through the tube 8. The high-voltage electrode 3 does not make contact with the mixture 1 to be treated. It is in a gas phase located in proximity to the mixture 1 to be treated, and in particular in a gas phase located above the surface 7 of the mixture 1 to be treated, as is illustrated in FIG. 39. The ground electrode 4 has an annular shape and encircles the tube 8. It is also in a gas phase located in proximity to the mixture 1 to be treated, and in particular in a gas phase located above the surface 7 of the mixture 1 to be treated, as is illustrated in FIG. 39. The plasma is then generated in the tube 8 between the ground electrode 4 and the high-voltage electrode 3 and propagates on exiting the tube 8 into the surrounding gas, which may or may not be identical to the gas flowing through the tube 8.

FIG. 40 shows one variant of FIG. 39, in which the ground electrode 4 is submerged in the mixture 1 to be treated.

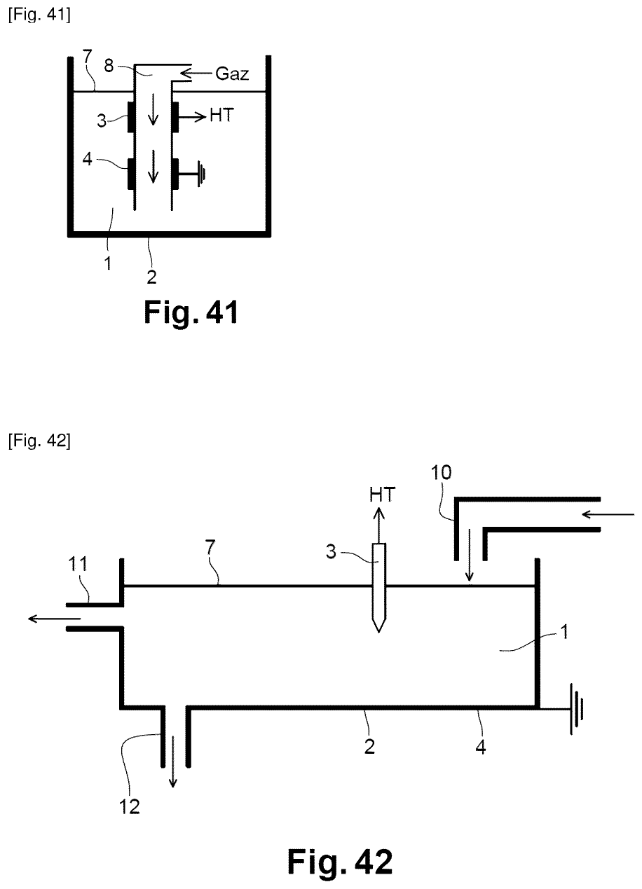

FIG. 41 shows one variant of FIG. 39, in which the high-voltage electrode 3 and the ground electrode 4 are submerged in the mixture 1 to be treated.

FIGS. 42 to 45: Examples of Processes According to the Invention in which a Stream of Mixture is Treated

FIG. 42 shows one example of a process according to the invention in which a stream of a mixture 1 comprising at least two liquid phases, and in particular an emulsion, is treated. The latter is introduced into a tank 2 formed by walls via a feed 10 for supplying a mixture 1 that opens into the tank 2. A plasma of corona type is generated between a high-voltage electrode 3 having a small radius of curvature, and in particular a tip shape, as illustrated in FIG. 42, and a ground electrode 4 having a large radius of curvature, and in particular a plane shape, as illustrated in FIG. 42. The high-voltage electrode 3 is submerged in the mixture 1 to be treated and the ground electrode 4 is formed by at least one wall of the tank 2. The mixture 1 is treated with the generated corona plasma and a separation of the two liquid phases of the mixture is obtained. The phase of lowest density is recovered via an outlet 11 formed in the upper part of the tank 2 and the phase of highest density is recovered via an outlet 12 formed in the lower part of the tank 2.

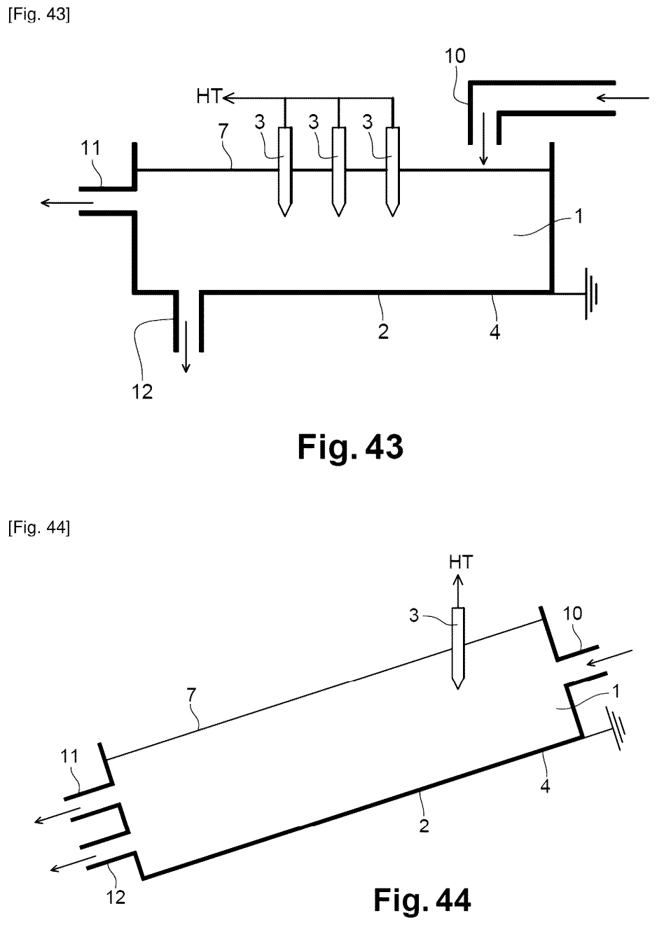

FIG. 43 shows one variant of FIG. 42 in which a plurality of high-voltage electrodes 3 are present, in particular three high-voltage electrodes 3, as illustrated in FIG. 43. The number of high-voltage electrodes 3 may be greater than three. Reference is then made here to an electrode array comprising three high-voltage electrodes 3 and one ground electrode 4.

FIG. 44 shows one variant of FIG. 42 in which the tank 2 is inclined so as to be able to treat a film of mixture 1 which flows within the tank 2. The variant illustrated in FIG. 44 thus makes it possible to treat a smaller height of mixture 1 compared with FIGS. 42 and 43.

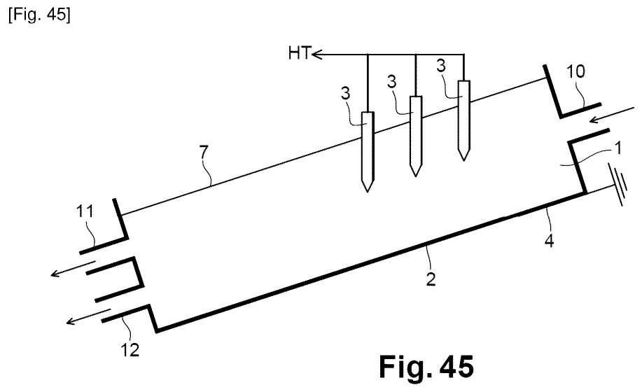

FIG. 45 shows one variant of FIG. 44 in which a plurality of high-voltage electrodes 3 are present, in particular three high-voltage electrodes 3, as illustrated in FIG. 45. The number of high-voltage electrodes 3 may be greater than three. Reference is then made here to an electrode array comprising three high-voltage electrodes 3 and one ground electrode 4.

In FIGS. 42 to 45, the high-voltage electrodes 3 may not make contact with the stream of the mixture 1 to be treated. They may be in a gas phase located in proximity to the stream of the mixture 1 to be treated, and in particular in a gas phase located above the surface 7 of the stream of the mixture 1 to be treated.

In FIGS. 43 and 45, the high-voltage electrodes 3 of the electrode array may be supplied by a single voltage generator. As a variant, the high-voltage electrodes 3 are each supplied by one voltage generator, these voltage generators being identical or not. Thus, the high-voltage electrodes 3 may each be supplied with one voltage, these voltages possibly being identical or not.

1. A process for treating a mixture of at least two liquid phases for separating the two liquid phases of the mixture, said method comprising the step of:
treating the mixture with a plasma.

2. The process as claimed in claim 1, wherein the two liquid phases are immiscible.

3. The process as claimed in claim 1, wherein the one of the two liquid phases is continuous and the other is dispersed in the continuous phase.

4. The process as claimed in claim 1, wherein one of the two liquid phases is aqueous and the other is an oil.

5. The process as claimed in claim 1, wherein the mixture is an emulsion.

6. The process as claimed in claim 5, wherein the emulsion is a simple emulsion, a multiple emulsion, or one or their mixtures.

7. The process as claimed in claim 1, wherein the mixture comprises a solid phase dispersed in at least one of the two liquid phases.

8. The process as claimed in claim 7, wherein the treatment of the mixture with the plasma not only separates the two liquid phases of the mixture but also separates the solid phase of the mixture.

9. The process as claimed in claim 1, wherein a stream of the mixture is treated.

10. The process as claimed in claim 1, wherein the duration of treatment with the plasma is between 1 second and 10 hours.

11. The process as claimed in claim 1, wherein the mixture is heated so as to raise it to a temperature ranging from 20° C. to 90° C., simultaneously with its treatment with the plasma.

12. The process as claimed in claim 1, wherein the mixture is stirred simultaneously with its treatment with the plasma.

13. The process as claimed in claim 1, wherein the plasma is generated between at least two electrodes across which electrodes a constant or periodic voltage is applied, having a sinusoidal, Gaussian or triangular shape, a sawtooth, square, rectangular or pulsed shape.

14. The process as claimed in claim 13, wherein the constant or periodic voltage has an amplitude between 10 V and 100 kV.

15. The process as claimed in claim 13, wherein the periodic voltage has a frequency between 1 Hz and 1 MHz.

16. The process as claimed in claim 13, wherein at least one of the electrodes does not make contact with the mixture to be treated.

17. The process as claimed in claim 13, wherein both electrodes make contact with the mixture to be treated.

18. The process as claimed in claim 1, wherein the plasma is chosen from a plasma of dielectric-barrier-discharge type, of corona type and of cold-plasma-jet type.

19. The process as claimed in claim 1, wherein the gas used to produce the plasma is chosen from a molecular gas a mixture thereof.

20. The process as claimed in claim 1, wherein the separation of the two liquid phases of the mixture, and optionally of the solid phase of the mixture, is irreversible.

21. The process as claimed in claim 1, wherein the duration of the separation of the two liquid phases of the mixture, and optionally of the solid phase of the mixture, is between 1 second and 10 hours.

22. The process as claimed in claim 1, wherein no chemical demulsifier, coagulant, flocculant or advanced oxidant is added to the mixture.

23. The process as claimed in claim 1, wherein at least one of the two liquid phases of the mixture is recovered after the separation of the two liquid phases of the mixture.

24. The process as claimed in claim 1, wherein the mixture is a fluid generated in the petroleum industry; a cutting fluid; and/or domestic, agricultural or industrial wastewater.

25. A process for treating wastewater containing at least one mixture of at least two liquid phases, wherein said wastewater is treated by implementing the process as claimed in claim 1.

26. The process as claimed in claim 25, wherein the wastewater to be treated is domestic, agricultural or industrial wastewater.

27. A process for treating an oil containing at least one mixture of at least two liquid phases, wherein said oil is treated by implementing the process as claimed in claim 1.

28. The process as claimed in claim 27, wherein the oil to be treated is a lubricating oil; a vegetable oil; or one of their mixtures.

29. An installation for treating a mixture of at least two liquid phases, including a wastewater or oil, as claimed in claim 1 said installation comprising:
a reactor intended to contain or containing the mixture, the wastewater or the oil to be treated, the mixture, the wastewater or the oil to be treated being able in particular to flow through the reactor in a continuous stream;
at least two electrodes, including at least one ground electrode and at least one high-voltage electrode, which are arranged so as to generate a plasma in contact with or in the mixture, wastewater or oil to be treated with a view to separation of the two liquid phases of the mixture, of the wastewater or of the oil;
at least one voltage generator for supplying the electrodes.
